(19) United States
(12) Patent Application Publication
(10) Pub. No.: US 2007/0193754 A1
(43) Pub. Date: Aug. 23, 2007

(54) Linear actuated reciprocating garden HOE

(76) Inventors: Carl L. Beckman, Fresno, CA (US); John Martin Beckman, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/360,838

(22) Filed: Feb. 23, 2006

(51) Int. Cl. A01B 33/00

(52) U.S. Cl. 172/41

(57) ABSTRACT

The linear actuated reciprocating garden hoe of the present invention is an effective and easy to use gardening tool for removing weeds and unwanted grasses and for cultivating ground. Specifically, the present invention discloses a reciprocating hoe having a hoe blade attached to a second end of a handle, a linear actuator mounted on the handle near the second end thereof and a linkage assembly interconnecting the linear actuator and hoe blade. A hoe mounting bracket mounts the hoe blade to the second end of the handle. The pivoting mechanism has a reciprocating rod connected to the linear actuator, a linkage bracket connected to the hoe blade and a linkage lever interconnecting the reciprocating rod and linkage bracket. Preferably, the range of reciprocation of the hoe blade is limited to a range of 2 to 3 millimeters to minimize risk to the user, bystanders or cultivated vegetation.

### REFERENCE TO RELATED APPLICATIONS

None.

### BACKGROUND OF THE INVENTION

A. Field of the Invention

The field of the present invention relates generally to earth-working tools for use in gardens, landscaped areas, agricultural fields and the like. In particular, the present invention relates to garden hoes that are utilized for preparing the soil for planting and for the cultivation of plants. Even more particularly this invention relates to motorized garden hoes having a power source to actuate a hoe blade and work the soil.

B. Background

As is commonly known, the standard garden hoe has long been an essential gardening tool for the home and commercial gardener to prepare a plot of land for growing fruit, vegetable or ornamental vegetation. The standard garden hoe, in its simplest form, comprises a long wooden handle having a flat steel blade at its lower end that is positioned generally perpendicular to the handle. Typically, the garden hoe is utilized to manipulate the topsoil, as well as a portion of the subsurface soil, for purposes of aerating the soil, breaking up of large dirt clods and removing weeds and unwanted grasses in order to prepare an area for cultivation or improve a cultivated area. The blade of the standard garden hoe is configured to strike the soil and penetrate its surface so as to cut the roots of the unwanted weeds and grasses and permit the soil to be turned over onto these plants as a way of hindering their growth.

Although cultivating an area with a hoe involves a certain amount of work, as with planting and maintaining the area generally, many people enjoy working on a garden, lawn or other landscaped area. For these people, working in the garden or on the lawn is both rewarding and relaxing. Many of the activities that are required to properly cultivate and maintain a garden or landscaped area require more than a minimal amount of physical exertion. For instance, utilization of the standard hoe requires the user to repeatedly raise and lower the hoe and move his or her arms in a generally downward chopping motion to direct the hoe blade into the soil. Depending on the size of the cultivated area and the hardness of the soil, this can require the user significant amount of effort and result in impact forces directed to the user's arms, shoulders and back. Unfortunately, many people who enjoy or would otherwise enjoy such gardening activities cannot do so due to physical limitations, such as back problems, arthritis and/or in one of a number of other ailments, or generally not being in sufficient physical shape for such activity.

Home gardeners, as well as commercial gardeners, often seek out weeding methods that promise to be more energy efficient in terms of the expenditure of manual labor. However, many alternatives to using a hoe for weeding are less effective, as well as physically or environmentally dangerous or inappropriate for use in the home or other small gardens. For example, herbicides, though widely used in commercial agriculture operations and, to some extent, by the home gardener to achieve results similar to that of the garden hoe, namely removal of weeds and undesirable grasses, are often environmentally harmful. In addition, the use of such chemicals may not as effective or as precise as hand weeding with a garden hoe. Alternative forms of weeding, such as flaming (hot capping) with a propane torch, which is widely used on young organic crops and other plants in appropriate circumstances, is often much too dangerous and, consequently, unsuitable for the home gardener as well as environmentally harmful by contributing to air pollution. Furthermore, delicate plants or plants that need to be grown in a tight configuration, such as those grown in nurseries and the home garden, limit or foreclose use of conventional mechanized weed management mechanisms, such as tractors and the like.

Both home and commercial gardeners have a need for a gardening tool that offers the precision of a hand-weeding tool, such as the standard garden hoe but, unlike the hoe, that is less physically demanding to use. One improvement has been the hula hoe, which developed from the need for tool that was both effective and easy to use. This tool is a type of scuffle hoe in which the head pivots back and forth, creating a pushing and pulling action just under the soil surface to cut newly emerging or shallow-rooted weeds and/or to break up any crust on the soil surface. Prior art showing common alterations to the basic configuration of the hula hoe are disclosed in U.S. Pat. No. 2,943,690 to Towt, which describes a pendulum hoe blade attached to a handle, U.S. Pat. No. 4,093,031 to Portz, which describes a pendulum-type hoe having a stirrup-shaped blade mounted to the fork of a handle that allows it to move in a back and forth motion and U.S. Pat. No. 4,377,212 to Malson, which describes a pendulum action garden hoe mounted to a vertically inverted U-shaped support frame allowing the hoe head to pivot back and forth.

While the aforementioned prior art patents describe improved garden hoes and some of their variations, they all have limitations that underscore the ergonomic disadvantages of the standard garden hoe, as well as the limits of the precision and accuracy necessary for the task of weeding and soil cultivation inherent to the task of landscaping. For instance, even a garden hoe with an pivoting head necessitates a degree of physical exertion to manually operate the push-pull movement, which can be fatiguing and painful for those having poor back health. In addition, utilization of the typical pivoting hoe is still substantially laborious for the professional gardener or landscaper whose job requires large plots of land or a number of plots to be worked. For the physically challenged, elderly or those who are not in proper physical shape, use of a pivoting hula hoe can still be physically challenging and somewhat difficult because it still requires the user to stand or bend over and exert a sufficient amount of force to achieve the push-pull motion in the soil that is necessary to yield the desired results.

Motorized garden hoes offer ergonomic advantages over standard or other non-motorized hoes in that the user is not required to exert substantial force to either push and pull the hoe blade through the soil or hammer the hoe blade into the soil in order to achieve the desired hoeing benefits. A number of prior art patented motorized hoes utilize a power driven hoe blade to make the task of hoeing and other soil cultivating work easier and more efficient. For example, U.S. Pat. No. 1,801,017 to Major describes a power driven hoe having a drive shaft, clutch and head to which is mounted a shank connected to the hoe, allowing the hoe head to be reciprocated into the soil. U.S. Pat. No. 1,827,074 to Ditlevsen discloses a power operated hoe having a rigid handle, a hoe blade mounted on a shank that is pivotally attached to the handle and a drive mechanism to pivot the hoe blade in an up and down motion to effect the hoeing action. U.S. Pat. No. 2,550,522 to Bolongaro describes a reciprocatory hoe having a carriage assembly that is geared to a running wheel or electric motor to pivot the hoe blade in an up and down motion. U.S. Pat. No. 4,122,902 to Alexander discloses a motorized gardening tool having an electric motor interconnected to the hoe blade by a spring-connected linkage member, free of any bearings or friction contact, to reciprocate the hoe blade. U.S. Pat. No. 4,305,470 to Anderson discloses a power hoe that includes a drive shaft contained inside a housing, formed by the handle, that is driven by an electric hand drill positioned at the upper end of the handle. The cutting head can be adjusted so as to change the length of the stroke. The speed of the stroke varies with the rotating speed of the hand drill. To use this power hoe, the user grips the hand hold on the handle of the hoe with one hand and the handle of the hand drill with the other, requiring the user to use both hands at the same time. U.S. Pat. No. 5,850,882 to Link discloses a garden power tool having a battery powered motor connected to the cutting blades by a worm gear and gear wheel to rotate the tines of the cutting blade. U.S. Pat. No. 6,382,325 to Bovi discloses a portable motorized hoe having an electric motor that, via appropriate linkage contained in a shaft, powers the cutting blades. This patent also discloses a casing unit that forms the handle and frame for the hoe.

The advantage of a motorized garden hoe is that the hoe blade either rotates or reciprocates to cut into the soil so the user does not have to manually drive the hoe blade into the soil. A potential problem can occur, however, if the motorized hoe is very powerful and if there is no means to control the degree of rotation or reciprocation, resulting in the hoe blade cutting too deeply into the soil where it can damage roots and plants. Another problem is that a hoe blade which is rotating or reciprocating rapidly creates a degree of force that destabilizes the center of balance, potentially making the hoe difficult to control and, therefore, posing a danger to the user or any bystanders. In addition, many of the prior art motorized hoes do not simulate very well the work that is obtained by a standard or hula-type hoe. Instead, many of the prior art devices chop up the soil in more of a rotary tilling action than the relatively smooth operation of a non-motorized hoe.

What is needed therefore is an improved motorized garden hoe that combines the effectiveness and the precision of the hand-weeding and soil manipulation which is achieved with the standard garden hoe, with the ergonomic advantages of the hula or oscillating hoe and the convenience and reduced physical requirements of a motorized garden hoe. A preferred motorized hoe will have a motor-driven reciprocating blade so that the user does not have to push and pull or “hammer” the ground in order to remove weeds or unwanted grasses from a garden or other landscaped area. The preferred garden hoe should be configured in such a way as to allow the user to control the reciprocation of the hoe blade in order to cut weeds and grasses and turn top soil in a manner such that the cultivated plants and roots are not damaged by the hoe action. The preferred reciprocating garden hoe should be lightweight and constructed so the motor and its housing does not result in a tool which is unbalanced, heavy or awkward to use, making it easy to operate by gardeners and other individuals with varying levels of physical ability.

### SUMMARY OF THE INVENTION

The linear actuated reciprocating hoe of the present invention provides the benefits and solves the problems disclosed above. That is to say, the present invention discloses a garden hoe that maximizes the effectiveness and precision of hand-weeding and soil manipulation found with the standard garden hoe and increases the ergonomic advantages of the hula or oscillating hoe by utilizing the convenience of a motorized garden hoe with a reciprocating blade, so that the user does not have to push and pull or “hammer” the ground in order to remove unwanted grass or weeds from a garden or other landscaped area. The present invention discloses a motorized garden hoe that is lightweight with a minimum of additional components. The reciprocating garden hoe of the present invention is configured in such a way as to control the degree of reciprocation of the hoe blade, which limits the difficulty associated with a fast-moving blade allowing the user to more precisely cut weeds and grasses and turn top soil, while significantly reducing the likelihood that the user will lose control of the hoe and damage cultivated plants and roots.

In one general aspect of the present invention, the linear actuated reciprocating garden hoe comprises an elongated handle having a first end and a second end, a hoe blade pivotally disposed at the second end of the handle, a linear actuator attached to the handle and a linkage assembly interconnecting the linear actuator and the hoe blade such that the reciprocating motion of the linear actuator is converted to pivot the hoe blade. In the preferred embodiment, a hoe mounting bracket attaches the hoe blade to the second end of the handle and the linear actuator is mounted at or near the second end of the handle using one or more actuator mounting brackets. A variety of different types of hoe blades can be utilized with the reciprocating garden hoe of the present invention, including the standard straight edge blade and a hula or stirrup type of hoe blade. The preferred linkage assembly comprises a linkage bracket connected to the hoe blade, a reciprocating rod connected to and reciprocated by the linear actuator and a linkage lever interconnecting the linkage bracket and the reciprocating rod. The linkage assembly is configured to utilize the reciprocating motion of the linear actuator to pivot the hoe blade for use to cultivate soil and/or remove weeds and unwanted grasses therefrom. In a preferred embodiment, the linkage assembly is configured to limit the pivoting motion of the hoe blade to approximately two to three millimeters so that the reciprocating hoe can be used without significant risk to the user, bystanders or the cultivated plants. In the preferred embodiment, the reciprocating hoe of the present invention is made out of generally lightweight and sufficiently sturdy materials and is advantageously balanced so that it can be utilized by a variety of people of varying physical abilities.

In use, the reciprocating hoe of the present invention is held relative to the ground in a conventional manner, such as one holds a standard hoe or a hula hoe, with the handle at an angle and with the cutting blade positioned on the ground. In the preferred embodiment, the reciprocating hoe has a control switch that the user activates to turn on the linear actuator to initiate reciprocation of the linear actuator and pivoting of the hoe blade. The user positions the cutting blade onto the ground surface to be worked and moves across the ground. Because the linear actuator pivots the hoe blade, the user will not have to utilize his or her arms, shoulders and back to hoe the desired area. Because the length and speed of the stroke of the hoe blade's cutting edge reciprocates within a limited range of motion, creating a controlled arc of the cutting edge, the reciprocating hoe of the present invention provides a more precise cutting and working of the soil with lower risks to the user, bystanders and cultivated plants.

It is therefore the primary objective of the present invention to provide an improved reciprocating hoe that provides the advantages discussed above and overcomes the disadvantages and limitations associated with presently available hoes that are utilized for soil cultivation.

It is also an important objective of the present invention to provide a reciprocating garden hoe that increases the ergonomic advantages of the hula or oscillating hoe by substantially reducing the amount of physical force that needs to be exerted by the user in order to remove unwanted grasses or weeds from a garden or other landscaped area.

It is also an important objective of the present invention to provide a motorized reciprocating garden hoe that is configured to give the user a controlled and sustained reciprocation of the hoe blade in order to cut weeds and grasses and to turn top soil without damaging other plants and roots.

It is also an important objective of the present invention to provide a motorized reciprocating garden hoe that is lightweight and constructed such that the motor does not result in a tool which is unbalanced or awkward to use, making it easy to operate by gardeners and other individuals with varying levels of physical ability.

It is also an important objective of the present invention to provide a reciprocating garden hoe that has a hoe blade attached at one end of a handle, a linear actuator mounted on the handle towards the hoe blade and a linkage assembly interconnecting the linear actuator and hoe blade so as to pivot the hoe blade for use to hoe a plot of land, wherein the linkage assembly is configured to limit the range of the pivotal movement of the hoe blade.

The above and other objectives of the present invention will become readily apparent and are explained in greater detail by reference to the attached figures and the description of the preferred embodiment which follows. As forth herein, the present invention resides in the novel features of form, construction, mode of operation and/or combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a linear actuated reciprocating hoe configured according to the principles and concepts of a preferred embodiment of the present invention;

FIG. 2 an isolated side view of the linear actuator and hoe blade of the reciprocating hoe shown in FIG.1;

FIG. 3 is a top view of the linear actuator and hoe blade of FIG. 2;

FIG. 4 is an isolated side view of the actuating mechanism of the reciprocating hoe of FIG. 1; and

FIG. 5 is an isolated side view of the connecting mechanism of the reciprocating hoe of FIG. 1.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represent one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of this disclosure, references are generally to the primary embodiment which is to use of the present invention as a reciprocating garden hoe, however, it is understood that the disclosure herein may apply to other types of devices having similar earth working, cutting and tilling uses.

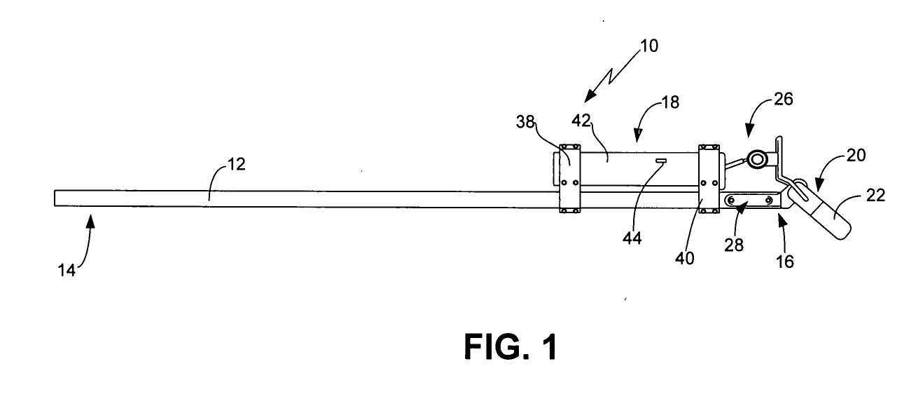

A linear actuated reciprocating garden hoe that is manufactured out of the components and configured pursuant to a preferred embodiment of the present invention is shown generally as 10 in the figures. As shown in FIGS. 1 through 3, reciprocating hoe 10 of the present invention has an elongated handle 12 having a first or upper end 14 and a second or lower end 16, a linear reciprocating mechanism 18 mounted on handle 12, a hoe blade assembly 20 having a work object such as hoe blade 22 with at least one cutting edge 24 and a linkage assembly 26 that interconnects reciprocating mechanism 18 and hoe blade 22. As known in the art, hoe blade assembly 20 includes a hoe mounting bracket 28 that fixedly mounts hoe blade 22 to the second end 16 of handle 12 using one or more connectors, such as bolts 30. In the preferred embodiment, as best shown in FIG. 1, reciprocating mechanism 18 is mounted to handle 12 near second end 16 thereof. As well known in the art, handle 12 can be constructed from wood, fiberglass, nylon or a number of other composite or single materials that have sufficient strength to support the forces of the reciprocating hoe blade 22 while providing the preferred lightweight nature of the present invention. In addition, the actuating mechanism 18 can be enclosed within a housing unit, not shown, such that handle 12 and the linear actuator 18 form a unitary hoe body. These and other types of configurations for handle 12 are adaptable to reciprocating hoe 10 in the present invention.

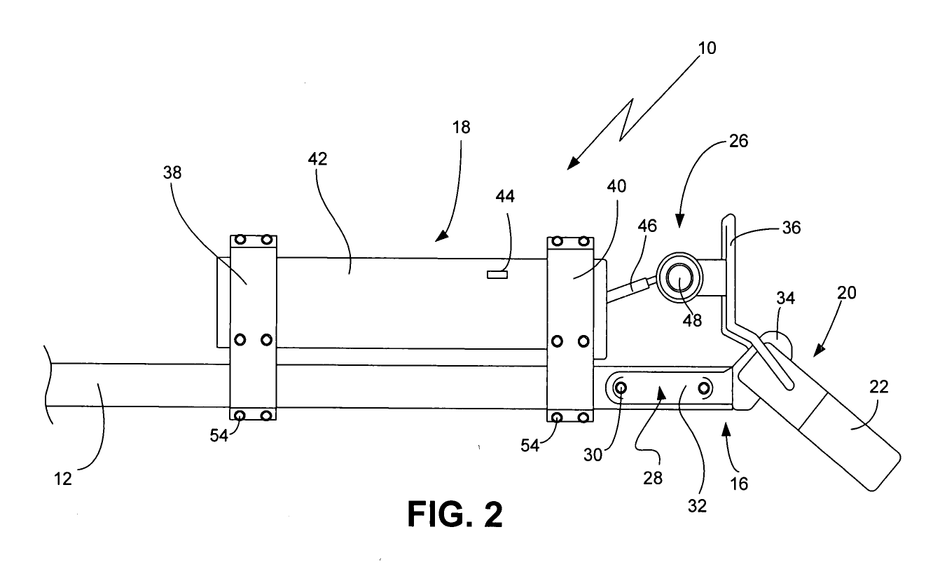

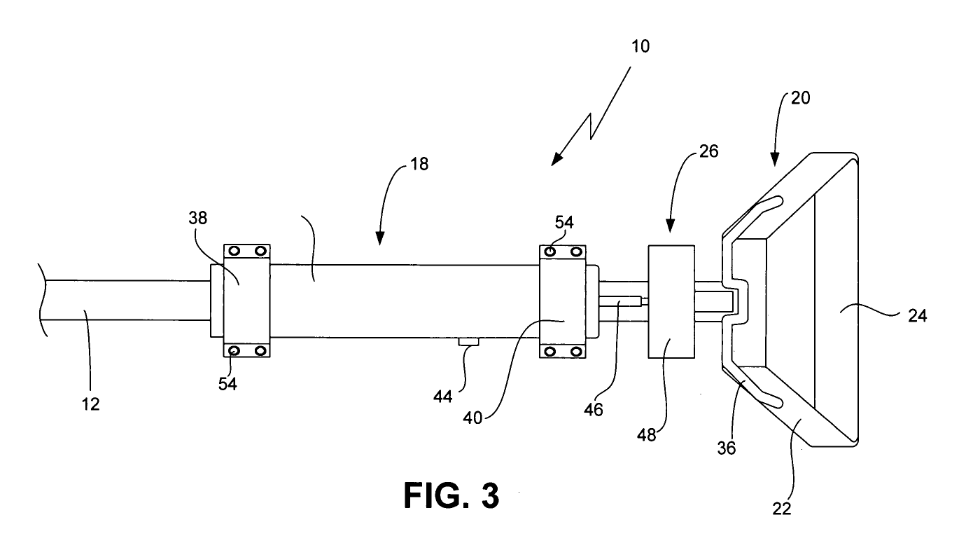

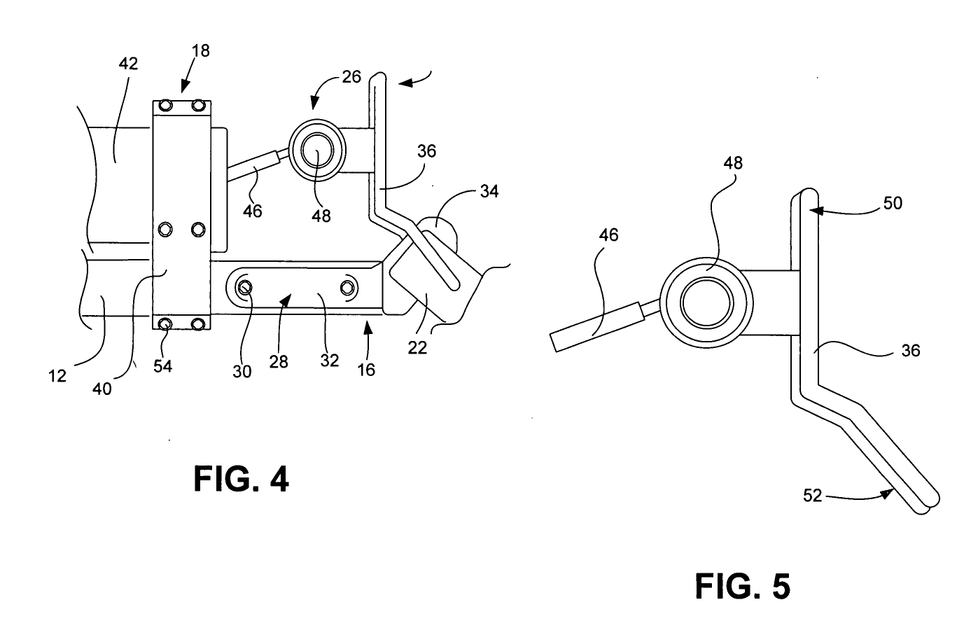

As shown in FIGS. 1 through 3, hoe mounting bracket 28 of hoe blade assembly 20 is configured to extend hoe blade 22 generally outwardly from second end 16 of handle 12. In the preferred embodiment, mounting bracket 28 is a generally L-shaped bracket having a handle mounting section 32 that is configured to align with second end 16 of handle 12 and a blade mounting section 34 that extends upwardly and outwardly from handle mounting section 32. Hoe blade 22 mounts to blade mounting section 34, as best shown in FIGS. 2 and 4. In the preferred embodiment, hoe blade 22 pivotally attaches to blade mounting section 34 in a manner that allows linkage assembly 26, in response to operation of reciprocating mechanism 18, to pivot hoe blade 22 to accomplish the hoeing objectives of the present invention (i.e., removal of weeds and undesirable grasses and preparation of soil). As best shown in FIG. 3, in a preferred embodiment of the reciprocating hoe 10 of the present invention, hoe blade assembly 22 includes a hula-type or stirrup-shaped hoe blade for hoe blade 22. As will be readily understood by those skilled in the art, however, the embodiment of reciprocating hoe 10 shown in the figures is only one of a number of different types and shapes of blades or heads that can be attached to handle 12, depending on the needs or desires of the user. For instance, a straight-edged hoe blade or a forked-shaped blade can be used with the reciprocating hoe 10 to break-up top soil of for other light-work duties in the garden. Likewise, although hoe mounting bracket 10 of the preferred embodiment includes handle mounting section 32 and blade mounting section 34 for a generally L-shaped hoe mounting bracket 28, the invention is not so limited. Hoe mounting bracket 28 can be of a variety of different configurations that are able to support hoe blade 22 at the second end 16 of handle 12 so that it can pivot in relation thereto.

In addition, as will be understood by those skilled in the art, the embodiment of the linear actuator driven reciprocating hoe 10 shown in the figures is only one of a number of different configurations for attaching hoe blade 22 to handle 12. For example, it is possible to incorporate hoe mounting bracket 28 into linkage bracket 36, thereby eliminating one of the brackets, by increasing the holding support of the generally U-shaped linkage bracket 36 connecting hoe blade 22 to linkage assembly 26. Alternatively, it is also possible to connect the handle end of hoe mounting bracket 28 to one or both of first actuator mounting bracket 38 or second mounting bracket 40 that is used to support the linear actuator 42 of reciprocating mechanism 18.

Linear actuator 42 of reciprocating mechanism 18 is configured to linearly reciprocate and, through linkage assembly 26, reciprocatively drive hoe blade 22 to obtain the desired hoeing action. In one preferred embodiment, linear actuator 42 is operatively controlled with control switch 44 that is mounted directly on linear actuator 42. As well known to those skilled in the art, control switch 44 can be a standard on/off switch or it can be configured to control the reciprocating speed of linear actuator 42. In a typical configuration of the reciprocating hoe 10 of the present invention, control switch 44 comprises an on-off switch that is of the rocker-type switch and is configured to turn on or off linear actuator 42 and, therefore, reciprocating hoe 10. In an alternative configuration, control switch 44 can indicate speed settings, such as high, medium and low, to control the speed of reciprocation of linear actuator 42. As known to those skilled in the art of electrical power tools, the control switch 44 can be configured as a touch-sensor pad, or as a dial or other type of control mechanism. In another configuration of the present invention, not shown, control switch 44 can be mounted to handle 12, such as at or near the first or upper end 14 of handle 12, and be connected by a lightweight electrical cable or wire directly to linear actuator 42 so as to control the operation of reciprocating mechanism 18, as is readily understood by those skilled in the art of electrical gardening tools.

Linear actuator 42 itself can be of the type that is commonly available and utilized for a number of different linear drive devices, including saws, that are capable of linearly actuating an external member or, with regard to reciprocating hoe 10 of the present invention, linkage assembly 26 and hoe blade 22. As will be recognized by those skilled in the art of fabricating mechanized tools, linear actuator 42 can house an appropriate electric or battery-operated motor, not specifically shown, for operation of reciprocating mechanism 18. Linear actuator 42 can attach by way of an electrical cord or other appropriate device to a source of electrical power, neither of which are shown in the figures but are well understood by those skilled in the art. Alternatively, linear actuator 42 can be configured to be detachable from handle 12 so as to accommodate recharging, with the addition of electrical contacts to handle 12 and linear actuator 42, to connect it to a remote device for recharging (as with other battery powered tools). Likewise, the power source may provide a variable or constant speed to drive the reciprocation of hoe blade 22. These features are all well known in the art of power tools.

As stated above, linkage assembly 26 interconnects linear actuator 42 and hoe blade 22 so as to reciprocate hoe blade 22 during the intended use of reciprocating hoe 10 of the present invention. In the embodiment shown in the figures, as best illustrated by FIGS. 4 and 5, linkage assembly 26 comprises the U-shaped linkage bracket 36 that attaches to and reciprocates hoe blade 22, reciprocating rod 46 extending outwardly from and operatively connected to linear actuator 42 and linkage lever 48 that interconnects reciprocating rod 46 and linkage bracket 36 so as to convert the linear motion of linear actuator 42 to the pivoting or back and forth motion of hoe blade 22. As best shown in FIG. 5, linkage lever 48 fixedly attaches at or near the first end 50 of linkage bracket 36 and the second end 52 of linkage bracket 36 fixedly attaches to hoe blade 22, which in the preferred embodiment is pivotally attached to hoe mounting bracket 28. As shown in the figures, the second end 52 of linkage bracket 36 is angularly disposed relative to the plane of the first end 50 thereof so as to beneficially change the in/out motion at first end 50 to the back/forth motion at second end 52 and hoe blade 22. With the above configuration, as shown in the figures, the linear movement of reciprocating rod 46, resulting from operation of linear actuator 42, will be converted by linkage lever 48 to an in and out motion at first end 50 of linkage bracket 36 to the reciprocating or back/forth motion of hoe blade 22. In a preferred embodiment of reciprocating hoe 10 of the present invention, linkage assembly 26 limits the back/forth motion of hoe blade 22 to approximately two to three millimeters. Although reciprocating hoe 10 can have linkage assembly 26 configured to obtain more or less reciprocation, the present inventors have found that this small amount of reciprocation provides the hoeing benefits desired without the risks associated with greater movement, namely the potential for harm to the user, bystanders or the vegetation that is being cultivated by use of reciprocating hoe 10. Configured as such, the controlled reciprocation of the hoe blade 22 produced by linear actuator 42 ensures precision cutting for the elimination of weeds and grasses. The degree of the reciprocating motion driven by linear actuator 42 creates enough force to be an effective tool for hoeing the surface and subsurface layers of the topsoil, while virtually eliminating the chance of a user losing control of reciprocating hoe 10 and damaging plants and roots other than those intended to be cut.

In one embodiment of the present invention, as shown in the figures, two actuator mounting brackets 38 and 40 secure linear actuator 42 to handle 12 using bolts 54. In an alternative embodiment, one or more mounting brackets mount linear actuator 42 to handle 12. Preferably, for balance and ease of use purposes, linear actuator 42 is mounted on handle 12 near second end 16 where the weight thereof will be beneficially applied to hoe blade 22 during use. As will be understood by those skilled in the art, however, the embodiment of the reciprocating hoe 10 shown in the figures is only one of a number of different configurations for attaching linear actuator 42 to handle 12. For instance, linear actuator 42 can be configured to be detachable from handle 12 for ease of storage or recharging by utilizing either one or more detachable mounting brackets or by configuring the mounting brackets 38 and 40 as open U-shaped brackets with connectors in which linear actuator 42 snaps into place. In another embodiment, linear actuator 42 is mounted in an abutting relationship with handle 12. Although not preferred, linear actuator 42 can be mounted towards first end 14 of handle 12 or anywhere else on handle 12. As stated above, if handle 12 is appropriately configured, linear actuator 42 can be disposed inside a chamber defined by handle 12. Alternatively, a housing member, not shown, can be used to cover linear actuator 42 and/or linkage assembly 26 so as to protect these components from debris and other foreign material.

The reciprocating hoe 10 of the present invention is operated by positioning handle 12 at an angle relative to the ground and moving it across the soil to be cultivated or otherwise over the area to be worked. Hoe blade 22 is position on or just above the ground and control switch 44 of linear actuator 42 of reciprocating mechanism 18 is switched on. The user manually controls the depth of penetration of the hoe blade 22 into the top soil as well as the range of the area covered, thereby assuring unwanted grasses and weeds are cut or loosened as well as the amount of top soil tilled. As to the manner of usage and operation of the present invention, hoe blade 22 and reciprocating mechanism 18 can be configured to suit a wide variety of needs and gardening tasks determined according to the anticipated users of reciprocating garden hoe 10.

Thus, although there is shown and described herein a specific form of the invention, it will be readily apparent to individuals skilled in the art that the present invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A linear actuator driven reciprocating hoe, comprising:
an elongated handle having a first end and a second end;
a work object pivotally disposed at said second end of said handle;
a linear actuator attached to said handle; and
a linkage assembly interconnecting said linear actuator and said work object, said linkage assembly configured to pivot said work object,
wherein said linear actuator is configured to reciprocate said linkage assembly and pivot said work object.

2. The reciprocating garden hoe of claim 1, wherein said work object comprises a hoe blade having one or more cutting edges, said hoe blade attached to said linkage assembly.

3. The reciprocating garden hoe of claim 1, wherein said linkage assembly comprises a linkage bracket connected to said work object, a reciprocating rod connected to said linear actuator and a linkage lever interconnecting said linkage bracket and said reciprocating rod, said linear actuator configured to reciprocate said reciprocating rod, said linkage lever configured to convert the reciprocating motion of said reciprocating rod to pivot said work object.

4. The reciprocating garden hoe of claim 3, wherein said linkage bracket has a first end and a second end, said linkage lever attached to said first end of said linkage bracket and said work object attached to said second end of said linkage bracket, said second end of said linkage bracket extending outwardly from said first end of said linkage bracket to pivot said work object.

5. The reciprocating garden hoe of claim 3, wherein said linkage assembly is configured to limit reciprocation of said work object to approximately two to three millimeters.

6. The reciprocating garden hoe of claim 1, wherein said linkage assembly is configured to limit reciprocation of said work object to approximately two to three millimeters.

7. The reciprocating garden hoe of claim 1, wherein said work object is attached to said second end of said handle.

8. The reciprocating garden hoe of claim 1 further comprising a hoe mounting bracket for attaching said work object to said second end of said handle.

9. The reciprocating garden hoe of claim 1 further comprising one or more actuator mounting brackets mounting said linear actuator to said handle.

10. The reciprocating garden hoe of claim 9, wherein said one or more actuator mounting brackets mount said linear actuator towards said second end of said handle.

11. The reciprocating garden hoe of claim 1, wherein said linear actuator is attached to said handle towards said second end of said handle.

12. A linear actuator driven reciprocating hoe, comprising:
an elongated handle having a first end and a second end;
a hoe blade pivotally disposed at said second end of said handle, said hoe blade having one or more cutting edges;
a linear actuator attached to said handle generally towards said second end of said handle; and
a linkage assembly interconnecting said linear actuator and said hoe blade, said linkage assembly configured to pivot said hoe blade,
wherein said linear actuator is configured to reciprocate said linkage assembly and pivot said hoe blade.

13. The reciprocating garden hoe of claim 12, wherein said linkage assembly comprises a linkage bracket connected to said hoe blade, a reciprocating rod connected to said linear actuator and a linkage lever interconnecting said linkage bracket and said reciprocating rod, said linear actuator configured to reciprocate said reciprocating rod, said linkage lever configured to convert the reciprocating motion of said reciprocating rod to pivot said hoe blade.

14. The reciprocating garden hoe of claim 13, wherein said linkage bracket has a first end and a second end, said linkage lever attached to said first end of said linkage bracket and said hoe blade attached to said second end of said linkage bracket, said second end of said linkage bracket extending outwardly from said first end of said linkage bracket to pivot said hoe blade.

15. The reciprocating garden hoe of claim 13, wherein said linkage assembly is configured to limit reciprocation of said hoe blade to approximately two to three millimeters.

16. The reciprocating garden hoe of claim 12 further comprising a hoe mounting bracket for attaching said hoe blade to said second end of said handle.

17. The reciprocating garden hoe of claim 12 further comprising one or more actuator mounting brackets mounting said linear actuator to said handle.

18. A linear actuator driven reciprocating hoe, comprising:
an elongated handle having a first end and a second end;
a hoe mounting bracket attached to said second end of said handle;
a hoe blade pivotally attached to said hoe mounting bracket, said hoe blade having one or more cutting edges;
a linear actuator attached to said handle generally towards said second end of said handle; and
a linkage assembly interconnecting said linear actuator and said hoe blade, said linkage assembly having a linkage bracket connected to said hoe blade, a reciprocating rod connected to said linear actuator and a linkage lever interconnecting said linkage bracket and said reciprocating rod, said linear actuator configured to reciprocate said reciprocating rod, said linkage lever configured to convert the reciprocating motion of said reciprocating rod to pivot said hoe blade.

19. The reciprocating garden hoe of claim 18, wherein said linkage bracket has a first end and a second end, said linkage lever attached to said first end of said linkage bracket and said hoe blade attached to said second end of said linkage bracket, said second end of said linkage bracket extending outwardly from said first end of said linkage bracket to pivot said hoe blade, said linkage assembly configured to limit reciprocation of said hoe blade to approximately two to three millimeters.

20. The reciprocating garden hoe of claim 18 further comprising one or more actuator mounting brackets mounting said linear actuator to said handle.
